(19) United States
(12) Patent Application Publication
(10) Pub. No.: US 2008/0047733 A1
(43) Pub. Date: Feb. 28, 2008

(54) SPIRAL HEATING WIRE

(75) Inventors: Dmitri Axakov, Waterloo (CA); Goran Bajic, Belle River (CA); Zoran Panic, Windsor (CA)

Correspondence Address: DOBRUSIN & THENNISCH PC, 29 W LAWRENCE ST, SUITE 210, PONTIAC, MI, 48342, US

(73) Assignee: W.E.T. Automotive Systems AG

(21) Appl. No.: 11/842,540

(22) Filed: Aug. 21, 2007

Related U.S. Application Data
(60) Provisional application No. 60/823,589, filed on Aug. 25, 2006.

(51) Int. Cl. H01B 7/29; H01B 5/10

(52) U.S. Cl. 174/110 R; 174/130

(57) ABSTRACT

The present invention includes a resistance heating wire comprising at least one uninsulated conductor strand and at least one additional strand spirally wound about a core strand in one layer, the at least one additional strand, the core strand, or both being non-conductive or conductive and having a non-conductive layer.

### CLAIM OF PRIORITY

The present invention claims the benefit of the priority of the filing date of U.S. Provisional Application Ser. No. 60/823,589 filed Aug. 25, 2006, which is herein incorporated by reference for all purposes.

### FIELD OF INVENTION

The present invention generally relates to a resistance heating wire, and more particularly to a heating wire with improved durability.

### BACKGROUND OF THE INVENTION

As resistance wires find wider use in many applications, more durable heating wires become desirable. Copper wire, the traditional material for heating wires, does not have the durability needed for many applications. Other conductive materials used for making wires also show deficiencies in durability or their improved durability is not cost effective. Other issues associated with resistance wire include undesirably narrow resistance ranges, thus limiting the wire versatility. Instability in the resistance of the wire due to intermittent connection of strands is also an issue because such wires do not consistently generate heat, potentially leading to hot spots or cold spots as the resistance of the wire fluctuates. Wherein broken or damaged strands may be a source of hot spots. While solutions to hot spots are known, they are not cost effective. For example, Litz wire does not have hot spots, but is expensive because each strand is individually insulated.

The present invention overcomes one or more of these problems.

### SUMMARY OF THE INVENTION

The present invention includes a wire comprising at least one conductor strand and at least one additional strand spirally wound around a core strand. The wire optionally may include a protective sheath.

In one aspect, the present invention includes a resistance heating wire comprising at least one uninsulated conductor strand and at least one additional strand spirally wound about a core strand to form a layer. The at least one additional strand, the core strand, or both being non-conductive or conductive and having a non-conductive layer.

In another aspect, the present invention includes a resistance heating wire comprising a flexible non-conductive core member including an axis, a plurality of conductive strands free of a non-conductive layer, the plurality of conductive strands being wrapped about the core member and located generally at an equal distance from the core axis. At least one non-conductive strand is located between two of the conductive strands and wrapped about the core member with the conductive strand. The at least one non-conductive strand being located at an equal distance from the core axis as the plurality of conductive strands, and an insulative sheath placed over the plurality of conductive strands, at least one non-conductive strand and the core member, wherein any current flowing through the wire is limited to the plurality of conductive strands.

### BRIEF DESCRIPTION OF THE DRAWINGS

In the drawings:

FIGS. 1A and 1B show a wire with multiple conductors strands and an additional dielectric strand with an optional protective sheath;

FIGS. 2A and 2B show a wire with a conductor strand and an additional insulated conductor strand;

FIGS. 3A and 3B show a wire with a conductor strand and an additional dielectric strand;

FIGS. 4A and 4B show in cross-section a wire where the strands are separated by a gap; and

FIGS. 5A and 5B show a wire with two sets of conductor strands separated by two additional strands, the conductor strands being variably spaced with respect to one another.

### DETAILED DESCRIPTION OF THE INVENTION

As used herein, ‘strand’ connotes a single filament of material. However, a braided bundle of filaments (such as braided, twisted, coiled, or otherwise group of filaments) or an unbraided bundle of filaments may also connote a single “strand.”

The present invention is predicated upon providing an improved resistance heating wire. The wire of the present invention may be employed in a variety of articles of manufacture including, without limitation, electronic articles such as door panels, wheels, floormats, radios, televisions, calculators, computers, or the like. The wire, however, is particularly suitable for use in heaters and even more particularly, the wire is suitable for use in heater systems of seats for use in automotive vehicles and other portions of automotive vehicles.

The wire of the present invention generally includes a core member or strand having at least one conductor and at least one additional strand wrapped therearound. The conductor strand, the additional strand, or the core strand may be formed of any suitable material that conducts electricity and has a resistance. Preferably, the conductor strand is free of a coating or layer such as an insulative layer and therefore uninsulated. Such materials may include metals, plastics, polymeric materials, elastomers, glass, organic materials, inorganic materials combinations thereof, or the like. Exemplary metals, which may partially or fully compose the conductor strand, include, without limitation, copper, aluminum, silver, tin, tungsten, gold, platinum, or the like. Exemplary polymeric materials, which may partially or fully compose the conductor strand, include conductive polymers such as polyaniline, conjugated polymers, doped polymers, combinations thereof or the like. In one embodiment, the conductor strand may be provided as a polymeric material having a dispersion of metal or carbon black. Some preferred materials include copper, and carbon, such as carbon fiber conductors. However, preferably, the conductor strand has a relatively small resistance; for example, in the range of about 0.05 to about 10 ohms per meter, and more preferably in the range of about 0.20 to about 5 ohms per meter.

Due to the potential oxidation of the strands, based upon the selected material, the conductor strand, the additional strand, or the core strand may include a conductive coating (e.g. plating or otherwise) surrounding a portion or entirety of the conductive material to reduce or eliminate oxidation of the conductive material. Exemplary conductive coatings include, without limitation, copper, aluminum, silver, tin, tungsten, gold, platinum, the like, or otherwise.

The wire of the present invention may further include at least one additional strand located between two conductor strands. The additional strand acts to separate one or more conductor strands into one or more groups and is found of a non-conductive insulating material or includes a non-conductive insulating layer. Advantageously, this limits the conductivity through the conductor strands to specific groups of conductor strands. As should be appreciated, with conductor strands coiled or wrapped around a core strand, the current traveling through the conductor strand is forced to follow the wrapping and cannot jump across the additional strand, as typical wires allow. The additional strand of the wire may be a dielectric strand or an insulated conductor strand. A combination of dielectric strands and insulated conductor strands may be used to make up a set of additional strands. However, in one preferred configuration, the wire includes similar additional strands. The non-conductive material or layer forming the additional strands may comprise any suitable dielectric and/or insulative material. For example, a textile thread or a polymer material such as a monofilament may be used to form the additional strands. In addition, the materials described below with regards to the core strand may also be suitable. In one embodiment, the material forming the additional strand includes a melting point greater than the melting point of the protective sheath, the core strand, or both. As previously mentioned, the additional strand may include a conductive material, which may include any of the materials used to form the conductor strand or otherwise.

Where the additional strand is a dielectric strand, it is contemplated that only the conductor strand may emit heat when current is applied thereto. Where the additional strand is an insulated conductor strand, both the conductor strand and the additional strand may emit heat when current is applied thereto. Minimal use of insulated conductor strands is desirable as the non-insulated conductor strand and additional strand combination is potentially more cost effective than the insulated conductor strand.

As with the additional strands, the core strand of the wire may comprise a non-conducting material, a material with a non-conducting surface. For example, a dielectric or non-conductive polymeric material may be used to form the core strand or form an insulating coating or cover thereto.

Preferably, the core strand, while flexible, has limited degree of plastic deformation, such that when stretched, compressed, or bent, the core strand returns to its original length, shape, or both. Nonetheless, it is contemplated the core strand may be plastically deformable to reduce cost of the wire. While flexible, the core strand primarily adds additional stiffness to the wire. As the wire stiffness increases, the wire may be limited to a minimum bending radius, which advantageously may prevent kinks in the wire, broken conductor or insulated strands, or both. This feature improves the durability of the wire. For example, the core strand may be formed as a monofilament from a generally stiff material. The core strand may contribute to at least about 50% (or even 60%, 75%, or more) of the total wire bending resistance. However, the additional strand may also provide some additional stiffness to the wire, which may enable the wire to include a smaller core strand.

The insulating layer, which may optionally be applied to the conductive materials of the wire (e.g., the conductor strand, the additional strand, or the core strand) may include an insulating material that achieves a non-conductive surface about the conductive material. Such non-conductive material may include enameled insulation, lacquer, metal-oxide insulation, or the like. In one exemplary process, anodizing the conductive material may be used to form a natural oxide layer of non-conductive material that may include metal oxide or even ceramic.

Any suitable combination of conductor strand(s) and additional strand(s) may be used to form the wire of the present invention. For example, a single conductor strand may be used with a single additional strand. A single conductor strand may be used with multiple additional strands. Multiple conductor strands may be used with multiple additional strands. The placement of an additional strand between a plurality of conductor strands may be advantageous as it may increase the durability of the wire, prevent shortage between strands, and prevent current from flowing across the strands by directing the current along the spiral route, about the core strand.

In a preferred embodiment, the number of uninsulated conductor strands to additional strands in the wire is the same. In another preferred embodiment, the uninsulated conductor strands and additional strands are wound in an alternating pattern, such that the conductive materials are spaced from one another. In one preferred embodiment, the ratio of conductor strands to additional strands is 1:1. However, in other preferred embodiments, the ratio of conductor strands to additional strands may be between 2:1 and 10:1 (e.g., 5:1, 6:1, 7:1, or otherwise). Other contemplated ratios of conductor strands to additional strands include between 1:2 and 1:10 (e.g., 1:3, 1:6, 1:8, or otherwise). Optionally, the additional strands may be added to achieve required resistance and fill space around the core strand or between the conductor strands to reduce the potential shift of conductor or additional strands along the surface of the core strand. As the strand ratio reaches 1:1, it is possible to maximize the potential reduction of hot-spots that may be formed within the wire. Advantageously, by including only a single additional strand with the one or more conductor strands improvements in durability and cost reduction of the wire may be achieved.

It is contemplated that the conductor strand, the additional strand, the core strand, or combinations thereof may be electrically connected at one or more locations along the length of the wire to achieve an optimal final resistance of the wire. This may include electrical connection at one or both ends of the wire, at one or more locations between the ends of the wire, or can be combinations thereof. It is further contemplated that one or more conductive components may be energized with a common or different current source. For example, the core strand may be electrically connected to a power source to form and emit heat.

The conductor strand and the additional strand are preferably spirally wound around the core strand such that the strands preferably lie in a single layer about the core. By winding the strands in a single layer, interconnection between two conductor strands or coils of a conductor strand can be prevented due to the separation provided by the additional strand. A single layer winding or of strands is preferable to a multiple layers because the single layer winding provides a higher degree of protection against interconnections as there will be less movement of the strands with respect to one another, thereby ensuring conductor strands do not contact one another. Another benefit of a single layer winding by placing the conductor strands around the core strand is that the wire may show improved cool down times compared to wires with conductors in the core or the center of the wire. This is because the conductor strands are closer to the surface of the wire and thus have less insulation (or no insulation at all). In one preferred configuration, the strands are wound so that they are adjacent to one another (and optionally may be touching) to improve the stiffness of the wire thereby decreasing its bending radii. However, it is contemplated that at least a portion of an exterior portion of the core strand may be free of a conductor strand or an additional strand, thereby forming gaps between the strands.

The direction of the winding may be in either direction (e.g., clockwise or counter clockwise) along the length of the wire. For example, a positive or negative winding angle may be used. The winding angle, alpha or α as shown in FIG. 2, is the degrees of inclination from a longitudinal axis of the wire. The pitch or winding period of the strands provides the required length of strand that is needed for a given length of wire. The pitch is determined by π*(D+d)/tan(alpha) where D is the core strand diameter, d is conductor or additional strand diameter and alpha is the winding angle.

The winding angle may be selected to form the desired resistance of the heating wire. With a larger winding angle, more length of conductor strand is placed along a given length of the wire, thereby providing a higher resistance and heating for that given length of wire. With a smaller angle to the winding, less length of conductor strand will be placed on a given length of wire, thereby providing a lower resistance and heating for that given length of wire.

Moreover, the number of strands (conductor or additional strands) also influences the potential resistance and heating of the wire. As more strands are added around the core, the smaller the possible winding angle compared to a wire with fewer strands, which is based upon the conductor strand to additional strand ratio. By, decreasing the number of strands, a higher resistance in the wire may be achieved without increasing the diameter of the wire. Alternatively, a higher resistance may be achieved by increasing or decreasing the ratio of conductor strands to additional strands. The result is a high resistance wire without increasing the diameter of the conductor strand or the wire; which may provide a materials cost savings and a reduced need to modify production equipment.

In one preferred embodiment, when a metal conductor strand (e.g. comprising copper) is use with an elastic polymer core strand and a protective sheath, the winding angle is more than 45°. Such a winding angle provides better durability compared with wires with smaller winding angles. For wires with smaller winding angles, when the wire is stretched, the core and conductor strands are stretched. After releasing the wire, the core strand may generally return to about its original length, however, the conductor strands may not return to its original length and therefore no longer fit tightly into the previous compartment, thus allowing the strands to squirm. If they break, they might puncture through the protective sheath. Larger winding angles help reduce the amount the conductors are stretched and thus reduce the likelihood of breakage and puncture of the sheath. In the alternative, if a winding angle of less than about 45° is desired a thicker protective sheath may be used.

In another embodiment, the resistance of the wire may be affected by varying the number of strands while maintaining the pitch of the winding. For example, a wire with one conductor strand will have a resistance greater than a wire with two conductor strands, assuming both wires have the same diameter and both wires are wound at the same pitch. Of course, for this to be the case, the single conductor strand wire will need a large enough pitch to fit the second conductor strand and the second dielectric strand. To maintain pitch while adding or removing strands, the diameter of the core strand may be varied or the winding angle varied.

The diameter of the conductor strand, additional strand, and the core strand of the wire may comprise any suitable size to achieve desired heating and durability. For example, it is contemplated that the diameter of the wire may be based on the level of electricity provided to the wire, the winding configuration, the desired heat output, or combinations thereof. This may be further based, at least in part, upon the material forming the strand. The diameter of the additional strand may or may not be the same as the diameter of the conductor strand. Preferably, the additional strand provides separation between the conductor strand or coil or adjacent coils of conductor strands. As such, the diameter of the additional strand may be equal to the conductor strand or may be smaller (e.g., ½, ⅓, or otherwise) or larger (e.g., twice, three times, or otherwise). However, in one preferred embodiment, the diameter of the additional strand is at least about 1/3 the diameter of the conductor strand. In other preferred embodiments, the diameter ratio of the additional strand to the conductor strand may range from about 1:2 to as high as about 2:1 and preferably is about 1:1.

It is also contemplated that the diameter of the strands may vary or remain consistent from one conductor strand to another, from one additional strand to another, from one conductor strand to one additional strand, or combination thereof throughout the wire. The ability to change the diameters of the strands, particularly the conductive strands, provides the ability to further change the resistance of the wire and hence the heat output.

In one embodiment, the resistance of the wire varies by less than about 20% between a minimum resistance (Rmin) and a maximum resistance (Rmax) over a given length of the wire (e.g. one meter or ten meters). Preferably, the resistance varies by less than about 10% between Rmin and Rmax.

Optionally, the wire of the present invention may include a protective sheath formed of an insulating material. The protective sheath may be formed of one or more polymeric materials, which may include plastics, thermoplastics, elastomers, combinations thereof or the like. Exemplary materials include, without limitation, silicon, polytetrafluoroethylene (PTFE), polyvinylchloride (PVC), polypropylene, high-density polyethylene (HDPE), low-density polyethylene (LDPE), fluorinated or chlorinated polyethylene, fluoroethylene propylene, polyfluoroethylene (PFE), combinations thereof or the like. It is contemplated that the materials mentioned may form a single homogeneous covering or a non-homogeneous covering (e.g., a sheath having two or more layers). In a preferred embodiment, the protective sheath or a portion of the protective sheath may be activatable upon the application of a condition (e.g. upon the application of heat or energizing the conductor to produce heat). U.S. Patent Publication 2004-0094534, which is hereby incorporated by reference.

The following descriptions of embodiments of the present invention should be considered non-binding as others exists as described herein.

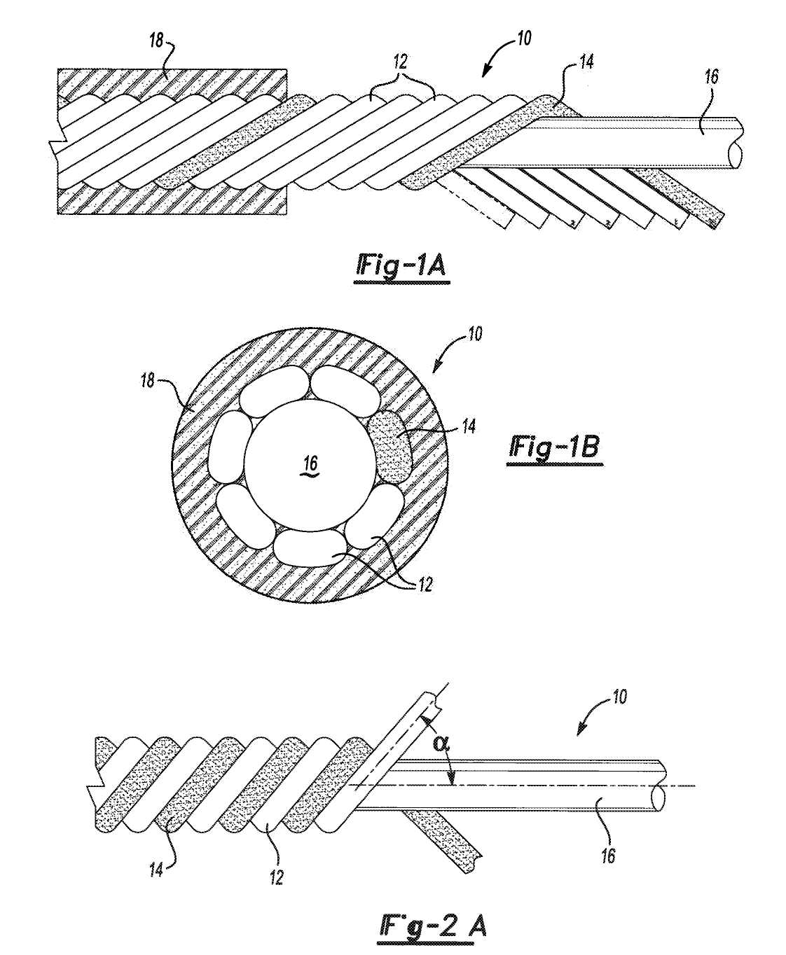

In a first embodiment, as shown in FIGS. 1A and 1B, the wire 10 comprises a plurality of uninsulated conductor strands 12 and an additional strand 14 wound around a core strand 16, with an optional protective sheath 18. The configurations shown and described in this embodiment, six conductor strands are used with one additional strand. The conductor strands and the additional strand are adjacently placed about the core strand such that there are no appreciable gaps formed therebetween. Also, the additional strand separates the conductor strands such that current spirally runs about the core strand.

In a second embodiment, as shown in FIGS. 2A and 2B, the wire 10 comprises a plurality of conductor strands 12 with an equal number of additional strands 14 spirally wound around core 16. In this configuration, the additional strands include a layer of insulation over a conductive material. This provides the ability to allow the additional strand to include a parallel current originating from the same current source as the conductor strands or a different current source. As in the embodiments of FIGS. 1A and 1B, the conductor strands and the additional strands are adjacently placed such that there are no appreciable gaps formed therebetween.

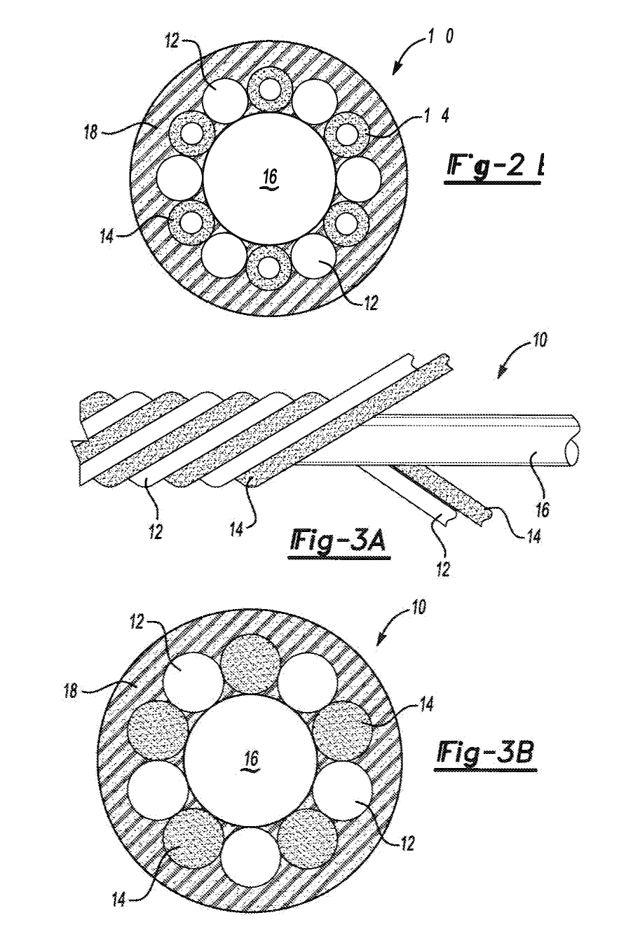

In a third embodiment, as shown in FIGS. 3A and 3B, the wire 10 comprises a plurality of conductors strands 12 and additional strands 14 spirally wound around core strand 16. The conductor strands and additional strands are alternatively placed to form a 1:1 ratio. As with previous embodiments, the strands are adjacently placed to the core strand and to each other such that no appreciable gap is formed.

As shown in FIGS. 2A and 3A, the pitch of the winding may be varied. For example, the winding angle alpha of the embodiment of FIG. 1 is larger as compared to FIG. 3A. This provides greater resistance (and heating) than the second wire over a given length assuming characteristics of the wires shown in FIGS. 2A and 2B and FIGS. 3A and 3B (e.g. strand arrangement, diameter, otherwise) are the same.

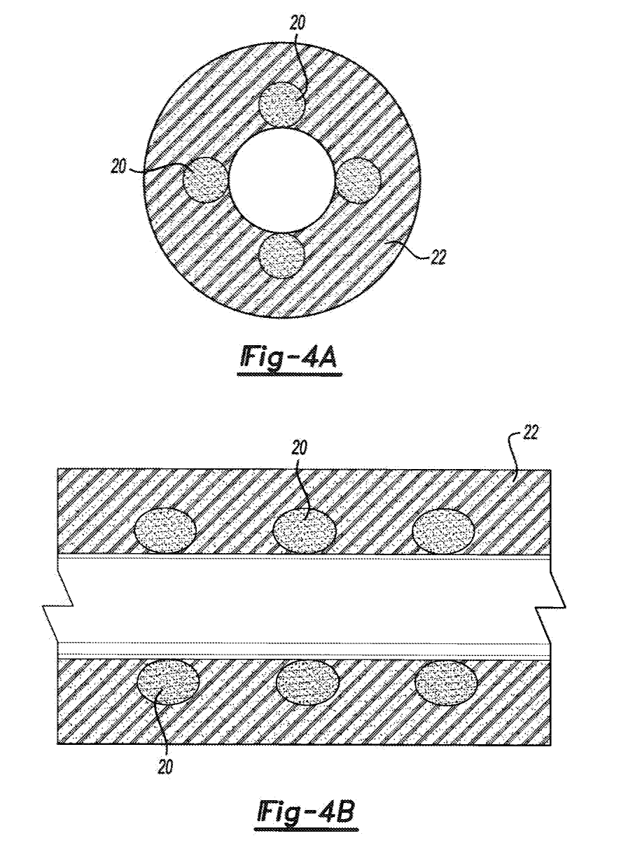

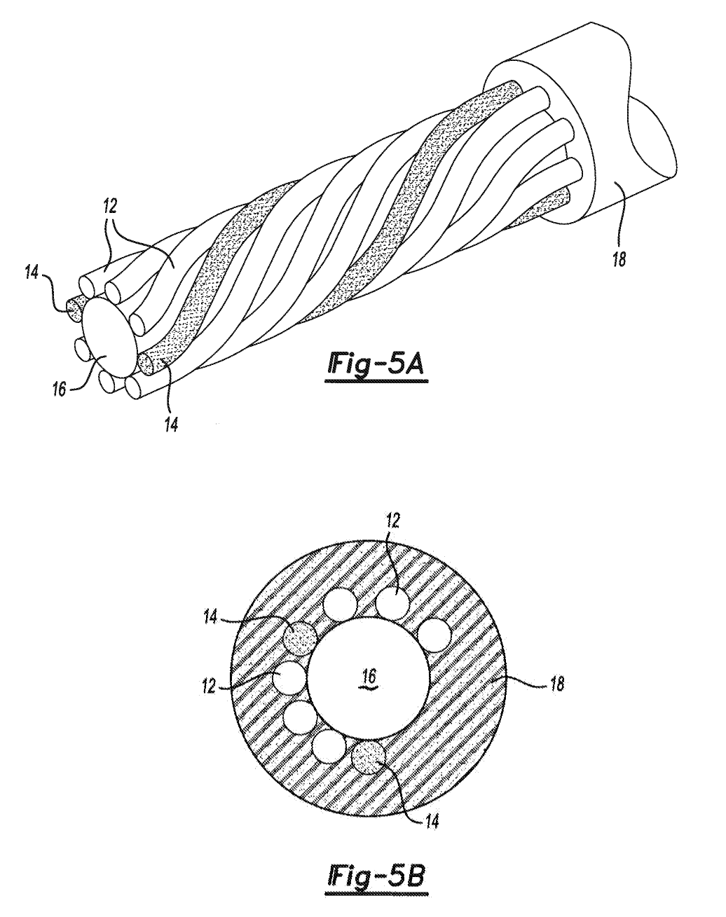

In an alternate embodiment as shown in FIGS. 4A and 4B, the pitch of the winding for the strands is increased so that the strands 20 are not touching one another. In this confiduration, a gap is formed between the individual strands wrapped about the core strand. Preferably, the strands 20 comprise conductive strands as in any of the strands described herein. However, it is contemplated that the strands 20 may comprise any combination of conductor strands and/or additional strands, the like of which have been described herein. Placement of an insulating protective sheath 22 over the conductor and additional strands would serve to further isolate the strands from each other, particularly the conductor strands.

In yet another embodiment, FIG. 5A shows a heating wire that includes two sets of conductor strands that are separated by a first additional strand and a second additional strand, the strands being spirally wound around a core strand. The winding of the strands may include various pitches thereby providing either consistent or random spacing between the strands along portions of the exterior surface of the core strand. FIG. 5B shows a cross-section of an uneven strand distribution that may result from the manufacturing of the heating wire, occur during use, or by design, wherein the additional strands maintain separation of the sets of conductor stands.

In the configurations shown and described, the core strand prevents over bending of the wire thus reducing the likelihood of hot spots due to broken wires. Furthermore, the cost of the wire is reduced because insulation over the conductor strands is eliminated. Still further, the reliability of this embodiment is improved because the number of conductor strands that are engaged into an active circuitry will be maintained if the conductor strands become shifted along the core strand.

The wire of the present invention may be connected to a power source to provide energy to the wire and generate heat. For wires containing more than one conductor strand, the conductor strands are preferably connected in parallel with each other. While it is desirable that all of the conductor strands are connected to the power source, this is not required. Moreover, the described embodiments are tolerant to intentionally energizing only a portion of the conductor strands as a means for power level regulation; however, it is preferable for a majority of the conductor strands to be connected to the power source to achieve the full power. It is also contemplated, that an insulated additional strand, an insulated core strand, or both, having conductive material therein may be partially or completely energized so as to contribute to the emission of heat from the wire, or otherwise. Non-connection of some conductor strands to the power source may occur while still being within the scope of the invention.

It is contemplated that the wires of the present invention may be employed in a variety of articles of manufacture and may operate in a variety of capacities. The wire of the present invention, however, has found particular utility for use in heaters. According to one embodiment, the wire is attached to a substrate for forming a heater or at least a portion thereof.

The wire may be attached to a wide variety of substrates for forming a heater and the type of substrate will often depend upon the type of heater desired. Exemplary substrates include fabrics, panels, members, combinations thereof, or the like. Moreover, various materials may be employed for forming the substrate. For example, the substrate may be formed of fibrous materials, polymeric materials, metals, combinations thereof or the like. In preferred embodiments, the substrate is formed of a fleece material, a gauze material, a felt material, or combinations thereof.

For attaching the wire to the substrate, various attachments may be employed such as adhesives, fasteners, sewing, combinations thereof, or the like. It is also contemplated that the conductor may be interferingly attached to the substrate such as by interweaving the wire with the substrate. As yet another alternative, a portion of the protective sheath of the wire may activate (e.g., soften or melt) and adhere itself to or integrate itself with the substrate. For example, the temperature of the sheath be elevated by heating the sheath such that one or more portions (e.g., the portions having lower melting points) are softened for allowing the sheath to integrate itself with the substrate followed by lowering the temperature of the sheath such that the covering hardens and attaches itself and the wire to the substrate.

With regard to heaters formed with the wire of the present invention, it has been found that heaters are particularly suitable for integration to seats of automotive vehicles. Of course, conductors and heaters formed according to the present invention find utility in other articles of manufacture such as boats, furniture, or the like as well.

A heater according to the present invention may be located in various portions of an automotive vehicle seat such as a support portion, a backrest portion, a shoulder support portion, or a headrest. The heater may be located between the trim of the seat and the foam cushioning of the seat. The heater may also be integrated into the trim of the seat, an insert, the foam cushioning of the seat or combinations thereof.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

1. A resistance heating wire, comprising:
at least one uninsulated conductor strand and at least one additional strand spirally wound about a core strand in one layer, the at least one additional strand, the core strand, or both being non-conductive or conductive and having a non-conductive layer.

2. The wire of claim 1, wherein the at least one conductor strand includes a plurality of conductor strands spirally wound about the core strand.

3. The wire of claim 2, wherein the plurality of conductive strands are spaced from one another to substantially prevent current from flowing between the plurality of conductive strands.

4. The wire of claim 2, wherein the at least one additional strand includes a plurality of strands spirally wound around the core strand.

5. The wire of claim 4, wherein the at least one additional strand separates each of the plurality of conductor strands from one another.

6. The wire of claim 2, wherein the at least one additional strand comprises a single additional strand that separate at least two of the plurality of conductor strands.

7. The wire of claim 6, wherein current flowing through the wire spirals about the core strand.

8. The wire of claim 1, wherein the at least one conductor strand includes carbon.

9. The wire of claim 1, wherein the at least one additional strand is formed of a non-conductive material.

10. The wire of claim 9, wherein the core strand is formed of a non-conductive material.

11. The wire of claim 1, wherein the at least one additional strand includes a conductive core and a non-conductive outer layer.

12. The wire of claim 1, further comprising an insulative sheath covering the at least one conductive strand, the at least one additional strand, the core strand.

13. The wire of claim 1, further comprising a first conductive strand that is spaced from the at least one additional strand, the at least one conductive strand, or both.

14. The wire of claim 13, wherein the at least one conductive strand and the at least one additional strand form a plurality of strands spaced apart and wound about the core strand.

15. The wire of claim 1, wherein at least a portion of an exterior portion of the core strand is free of the at least one conductor strand and the at least one additional strand.

16. The wire of claim 1, wherein the at least one additional strand separates a plurality of conductor strands that are adjacently wound around the core strand or the at least one conductor strand separates a plurality of additional strands that are spirally wound around the core strand.

17. The wire of claim 1, wherein the ratio of the at least one conductor strand to the at least one additional is 1:1 and the at least one conductor strand and the at least one additional strand are spirally wound around the core strand in an alternating pattern.

18. The wire of claim 1, wherein the core strand comprises a conductive strand having an insulative coating thereover.

19. The wire of claim 18, wherein the core strand and at least one of the at least one conductive strand and the at least one additional strand are electrically connected at one or more locations along the length of the wire.

20. A resistance heating wire, comprising:
a flexible non-conductive core member including an axis; a plurality of conductive strands free of a non-conductive layer, the plurality of conductive strands being wrapped about the core member and located generally at an equal distance from the core axis;
at least one non-conductive strand located between two of the conductive strands and wrapped about the core member, the at least one non-conductive strand being located at an equal distance from the core axis as the plurality of conductive strands; and an insulative sheath placed over the plurality of conductive strands, at least one non-conductive strand and the core member,
wherein any current flowing through the wire is limited to the plurality of conductive strands.

21. The wire of claim 20, wherein the at least one non-conductive strand comprises a plurality of non-conductive strands separating each of the plurality of conductive strands such that current flowing through each of the conductive stands remains in the conductive strand through substantially the entire length of the wire.
